(19) United States
(12) Patent Application Publication
(10) Pub. No.: US 2025/0232557 A1
(43) Pub. Date: Jul. 17, 2025

(54) OBJECT SEGMENTATION FOR LIDAR POINT CLOUDS

(71) Applicant: NVIDIA Corporation, Santa Clara, CA (US)

(72) Inventors: Aljosa OSEP, Pittsburgh, PA (US); Tim MEINHARDT, Munich (DE); Francesco FERRONI, London (GB); Laura LEAL-TAIXE, Florence (IT)

(21) Appl. No.: 19/014,606

(22) Filed: Jan. 9, 2025

Related U.S. Application Data
(60) Provisional application No. 63/620,692, filed on Jan. 12, 2024.

(30) Foreign Application Priority Data
Nov. 8, 2024 (IT) 102024000025221

(51) Int. Cl. G06V 10/26; G06V 10/762; G06V 10/764; G06V 10/82; G06V 20/70

(52) U.S. Cl. CPC G06V 10/26; G06V 10/762; G06V 10/764; G06V 10/82; G06V 20/70

(57) ABSTRACT

In various examples, systems and methods are disclosed relating to learning and segmenting objects in lidar point clouds. A system can generate, for an image depicting an environment, a set of segmentation masks using an image segmentation model and the image, and can generate a set of tokens for the image using an image-text encoder model. The system can generate a segmented point cloud by transferring the set of segmentation masks to the point cloud representing at least a portion of the same environment depicted by the image. The system can update, using the segmented point cloud and the set of tokens, a machine-learning model to generate output segmentations for input point clouds.

### CROSS-REFERENCES TO RELATED APPLICATIONS

This application claims the benefit of and priority to Italian Patent Application No. 102024000025221, filed Nov. 8, 2024, and claims the benefit of and priority to U.S. Provisional Patent Application No. 63/620,692, filed Jan. 12, 2024, the contents of each of which are incorporated herein by reference in their entirety for all purposes.

### BACKGROUND

Light detection and ranging (LiDAR) data is useful for a variety of applications, including autonomous vehicle navigation and terrain mapping, among other applications. Such systems can operate by classifying different arrangements of points appearing in LiDAR point clouds, for example, using machine-learning models. Although certain approaches have trained machine-learning models to classify objects/features in LiDAR data using training data predefined and manually labelled classes, such approaches cannot be adapted to continually evolving class ontologies.

### SUMMARY

The techniques described herein address challenges associated with training/updating machine learning models for object segmentation in LiDAR point clouds. Annotated data for LiDAR point clouds is scarce, making it difficult to train/update effective perception models that process LiDAR data. Conventional techniques for generating such data are time-consuming and expensive, often involving manual annotation of objects within point clouds. While alternative approaches exist, they may not provide a scalable solution for directly classifying or segmenting arbitrary objects present in LiDAR point clouds.

To overcome these limitations, the disclosed systems and methods propose leveraging two-dimensional (2D) vision foundation models to generate pseudo-labels for LiDAR point clouds. This approach utilizes the output of a 2D vision foundation model, which can include segmentations of different objects or features depicted in a corresponding 2D image. Pre-trained feature generation models, such as image-text feature generation models (e.g., contrastive language-image pre-training (CLIP) models, etc.), can then be employed to automatically generate output tokens that include semantic information for classification within each segmented portion of the input image. These generated segmentations can subsequently be mapped to points within the corresponding LiDAR point cloud by transforming coordinate frames and applying density-based clustering to refine the mapping accuracy. This process can result in each point in the LiDAR point cloud being associated with a specific segmentation and its corresponding set of output tokens, effectively creating training data for LiDAR segmentation models.

Segmented LiDAR point clouds generated according to these techniques can be used to train/update a machine-learning model to class-agnostically segment features in captured LiDAR point clouds. The machine-learning model can be trained/updated to output tokens describing features of LiDAR point clouds in the same space as the features generated by the feature generation model. Text prompts (arbitrary text prompts, in one or more non-limiting embodiments) corresponding to desired features to be segmented in the LiDAR data can be provided as input to the feature generation model, which can be matched with the output of the machine-learning model at inference. The matching can yield a probability distribution over the prompts, enabling an arbitrary class vocabulary to be used to define the classifications of the output segmentations.

At least one aspect relates to one or more processors. The one or more processors can include one or more circuits. The one or more circuits can generate, for an image depicting an environment, a set of segmentation masks using an image segmentation model and the image. The one or more circuits can generate a set of tokens for the image using an image-text encoder model. The one or more circuits can generate a segmented point cloud by transferring the set of segmentation masks to a point cloud representing at least a portion of the same environment depicted by the image. The one or more circuits can update, using the segmented point cloud and the set of tokens, a machine-learning model to generate output segmentations for input point clouds.

In some implementations, the one or more circuits can remove at least one unlabeled point from the segmented point cloud. In some implementations, the machine-learning model comprises one or more transformer layers and one or more convolutional layers. In some implementations, the one or more circuits can transfer the set of segmentation masks to the point cloud further based at least on a density-based clustering function. In some implementations, the one or more circuits can update the segmented point cloud using an augmentation function.

In some implementations, the one or more circuits can generate an initial set of segmentation masks by providing the image as input to the image segmentation model. In some implementations, the one or more circuits can generate the set of segmentation masks using a non-maximum suppression function. In some implementations, the one or more circuits can generate the set of tokens using the image-text encoder model further based at least on the set of segmentation masks.

In some implementations, the one or more circuits can identify an input point cloud and an input prompt indicating a set of labels. In some implementations, the one or more circuits can generate a set of label tokens using the image-text encoder model and the set of labels. In some implementations, the one or more circuits can generate an output segmentation for the input point cloud using the machine-learning model and the set of label tokens, the output segmentation corresponding to the set of labels. In some implementations, the one or more circuits can generate a set of output tokens using the machine-learning model. In some implementations, the one or more circuits can identify at least one match between the set of tokens and the set of output tokens.

At least one aspect relates to a system. The system can include one or more processors. The system can obtain, using sensor data captured using a sensor, a point cloud representative of one or more objects in an environment. The system can generate, using an image-text encoder model, a set of label tokens corresponding to a set of labels corresponding to the one or more objects. The system can generate, using a machine-learning model, the point cloud, and the set of label tokens, a segmented point cloud identifying at least one label of the set of labels. The machine-learning model is updated based on one or more outputs of at least one of an image segmentation model or an image-text encoder model.

In some implementations, the image-text encoder model is included as part of the machine-learning model. In some implementations, the system can provide the point cloud and the set of classes as input to the machine-learning model to generate the segmented point cloud. In some implementations, the machine-learning model comprises one or more transformer layers and one or more convolutional layers. In some implementations, the system can receive the set of labels in a text prompt. In some implementations, the system can generate the segmented point cloud to include a respective objectness score for at least one point of the point cloud.

At least one aspect is related to a method. The method can include generating, using one or more processors, a set of segmentation masks using an image segmentation model and an image depicting an environment. The method can include generating, using the one or more processors, a set of tokens for the image using an image-text encoder model. The method can include generating, using the one or more processors, a segmented point cloud by transferring the set of segmentation masks to a point cloud representing one or more objects in at least a portion of the same environment depicted by the image. The method can include updating, using the one or more processors, using the segmented point cloud and the set of tokens, a machine-learning model to generate output segmentations for one or more input point clouds.

In some implementations, the method can include removing, using the one or more processors, at least one unlabeled point from the segmented point cloud. In some implementations, the machine-learning model comprises one or more transformer layers and one or more convolutional layers. In some implementations, the method can include transferring, using the one or more processors, the set of segmentation masks to the point cloud further based at least on a density-based clustering function.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing operations using a large language model, a system for performing operations using a vision language model, a system for performing operations using a multi-modal language model, a system implemented using an edge device, a system implemented using a robot, a system for performing conversational AI operations, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for learning and segmenting objects in lidar point clouds are described in detail below with reference to the attached drawing figures, wherein:

FIG. 1 is a block diagram of an example system for training/updating and executing machine-learning models for segmenting objects/features in point clouds, in accordance with some embodiments of the present disclosure.

FIG. 2 is a block diagram showing an example implementation of pseudo-labelling performed according to the techniques described herein, in accordance with some embodiments of the present disclosure.

FIG. 3 is a block diagram showing an example implementation of a zero-shot model updated using the pseudo-labels described herein, in accordance with some embodiments of the present disclosure.

FIG. 4 is a flow diagram of an example of a method for training/updating and executing machine-learning models for segmenting objects/features in point clouds, in accordance with some embodiments of the present disclosure.

FIG. 5A is an illustration of an example autonomous vehicle, in accordance with some embodiments of the present disclosure;

FIG. 5B is an example of camera locations and fields of view for the example autonomous vehicle of FIG. 5A, in accordance with some embodiments of the present disclosure;

FIG. 5C is a block diagram of an example system architecture for the example autonomous vehicle of FIG. 5A, in accordance with some embodiments of the present disclosure;

FIG. 5D is a system diagram for communication between cloud-based server(s) and the example autonomous vehicle of FIG. 5A, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

This disclosure relates to systems and methods for learning and segmenting objects in light-detection and ranging (LiDAR) point clouds, which may be used to train/update machine-learning models to classify arbitrary objects in LiDAR data. Perception models, including two-dimensional (2D) classification or segmentation models, can use annotated training/update examples to learn associations between input images and corresponding labels. Training/updating large 2D camera perception models is relatively straightforward due to the large number of available training/update datasets that include pre-labeled images.

However, annotated training/update data for three-dimensional (3D) LiDAR point clouds is relatively scarce, and the samples available for training/updating machine-learning models may not be diverse enough for robust, general perception tasks. Generating training/update data for LiDAR point clouds using conventional techniques is also time consuming and expensive, and involves manually capturing and annotating objects identified in point clouds using manual processes. Although other techniques may be used, such techniques fail to provide a scalable approach to data acquisition directly for classification or segmentation of arbitrary objects that may appear in LiDAR point clouds.

To address these shortcomings, the systems and methods of this disclosure provide techniques for generating pseudo-labels for LiDAR point clouds by leveraging the output of 2D vision foundation models (VFM). Pseudo-label generation can be used to generate segmentation labels for LiDAR point clouds captured concurrently with corresponding 2D images using calibrations between the sensors to map/unproject pixels in the 2D images to points in the LiDAR point clouds. Given an input image, a VFM can be used to generate segmentations for different objects or features depicted in the input image. Labels (e.g., class labels) can be automatically generated for these segmentations using a corresponding pre-trained feature generation model. In one or more embodiments, the feature generation model (e.g., a Contrastive Language-Image Pre-training (CLIP) model) can be an encoder model that generates output tokens identifying semantic features identified in each segmented portion of the input image, which can be provided text-promptable tokens in place of fixed class labels.

Once generated, the segmentations for the input image can be mapped to the points of the corresponding LiDAR point cloud. The segmentations are transferred to the points of the LiDAR point cloud by transforming the respective coordinate frame to the space of the LiDAR point cloud. Density-based clustering of masked LiDAR points may be performed to reduce noise and improve the accuracy of the transfer between the image data and the LiDAR point clouds. This mapping results in each point in the LiDAR point cloud that are covered by a camera image being paired with a corresponding segmentation, which can be associated with a respective set of output tokens generated by the feature generation model. These pairings can be used as training/update data for LiDAR segmentation models.

Segmented LiDAR point clouds generated according to these techniques can be used to train/update a machine-learning model (e.g., a transformer-based model) to class-agnostically segment semantic features in captured LiDAR point clouds. To generate segmentations for arbitrary objects or features, input text prompts corresponding to desired semantic features to be segmented in the LiDAR data are provided as input to the feature generation model. The machine-learning model can be trained/updated to generate output tokens describing features of LiDAR point clouds in the same space as the features generated by the feature generation model. The output tokens generated by the machine-learning model can then be matched to the output of the feature generation model at inference, yielding a probability distribution over the desired labels indicated in the input text prompts. This approach enables an arbitrary class vocabulary to be used to define the classifications of the output segmentations identified in the LiDAR point clouds.

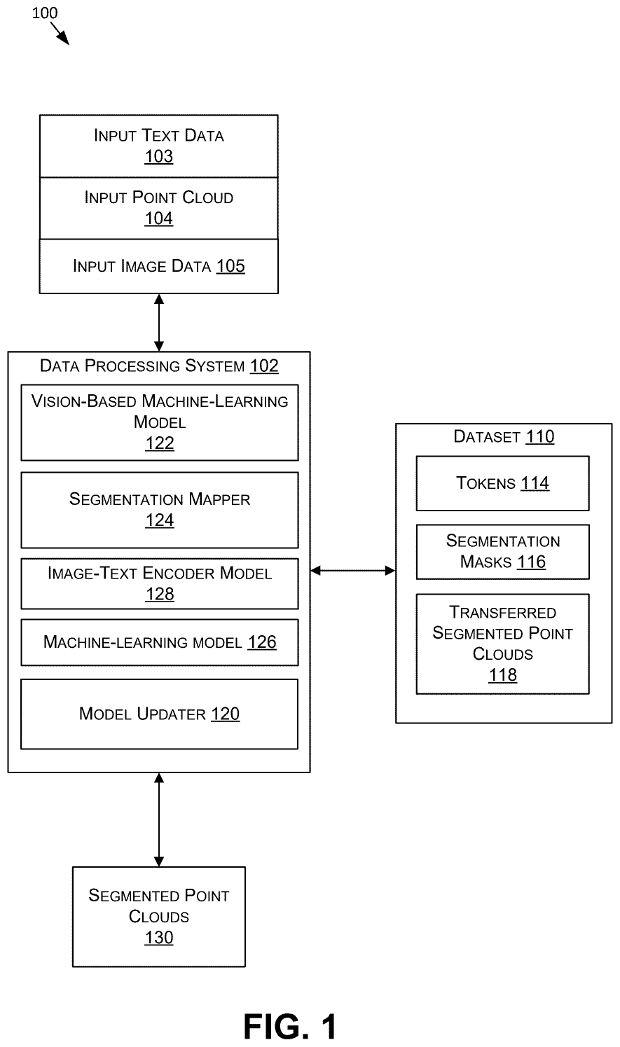

With reference to FIG. 1, FIG. 1 is an example computing environment including a system 100 for training/updating and executing machine-learning models for segmenting objects/features in point clouds, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 is shown as including a data processing system 102, a network system 104, input text data 103, input point cloud data 104, a dataset 110, and segmented point clouds 130. The data processing system 102 can store, maintain, access, or otherwise execute a vision-based machine-learning model 122, a machine-learning model 126, and an image-text encoder model 128. The data processing system 102 can execute a model updater 120 to update/train the machine-learning model 126 according to the techniques described herein. The data processing system 102 can execute a segmentation mapper 124 to transfer segmentation masks 116 generated from images using the vision-based machine-learning model 122 to an input point cloud data 104 to generate a transferred segmented point cloud 118. The transferred segmented point cloud 118, together with tokens 144 generated from the image-text encoder model 128 using the input text data 103 (e.g., to specify prompts) can be used by the model updater 120 as training/update data for the machine-learning model 126.

The data processing system 102 can include one or more processors, circuits, memory, and/or computing devices/systems that can perform the various techniques described herein. The data processing system 102 can be implemented, for example, in a cloud computing environment, which may maintain, update/train, and/or execute one or more vision-based machine-learning model(s) 122, machine-learning model(s) 126, and image-text encoder model(s) 128. The machine-learning model(s) 126 can be trained/updated according to the techniques described herein to generate output segmented point clouds 130 from input point cloud data 104.

The data processing system 102 can receive one or more input point clouds 104 to generate one or more transferred segmented point clouds 118 for training/updating the machine-learning model 126. Once trained/updated, the machine-learning model 126 can be executed by the data processing system 102 to automatically generate one or more segmented point clouds 130 without transferring segmentation masks 116 generated by the vision-based machine-learning model 122, as described in further detail herein. The input point clouds 104 may be any type of point cloud captured using any type of (e.g., emissive or non-visual) sensor, such as a LiDAR sensor, a RADAR sensor, an ultrasonic sensor, among others. The input point cloud 104 may be received or retrieved from one or external computing systems, provided in a request to process the input point cloud 104, or maintained in storage of the data processing system 102 for processing. The input point cloud 104 may include any number of points in a three-dimensional (3D) space.

The input point cloud 104 can include any number of points captured via one or more sensors. The points in the input point cloud 104 can be stored in one or more data structures that define the position of the points relative to a predetermined frame of reference. The points in the input point cloud 104 may include raw or processed measurements from a sensor. In an example where an input point cloud 104 represents LiDAR data, each point in the point cloud may correspond to a respective emitter of the LiDAR sensor, and can be stored with an indication, or otherwise encoded with an indication of the emitter corresponding to the respective point. In some implementations, multiple points may correspond to the same emitter, but may be captured at different distances from the emitter. For example, in some implementations, emitters of a LiDAR sensor can capture multiple echoes from the same emission, each of which may be represented as corresponding point in the input point cloud 104.

The points in the input point cloud 104 may collectively form a 3D representation of an environment. Each point in the input point cloud 104 may be associated with an intensity value, for example, representing an intensity of an echo detected by the sensor, and may be associated with a 3D position value. In some implementations, the 3D position value may be or may include a distance value from a predetermined point in 3D space representing the position of the sensor (e.g., the location from which a signal was emitted). In one example, the input point cloud 104 can be generated using one or more LiDAR sensors (and/or other types of sensors, cameras and/or scanners) positioned on a vehicle that navigates through an environment. The input point cloud 104 may include metadata for the sensor(s) used to generate the input point cloud 104. The input point cloud 104 can be received from any suitable source, including from one or more sensors or one or more external computing systems.

The input text data 103 can include a text prompt indicating a set of natural language labels that are to be identified within input image data 105 and/or input point cloud 104 using the various segmentation techniques described herein. The input text data 103 includes textual instructions, sometimes referred to as prompts, which specify objects or features of interest for identification within input point clouds 104. The format of the input text data 103 can vary and may include lists of target objects or features in a natural language. Examples of the input text data 103 may include explicit lists of objects/features, such as “1. cars, 2. pedestrians, 3. traffic lights . . . ” or instruction-based prompts such as “only segment buildings, roads, and vegetation,” or “locate bicycles, motorcycles, and construction equipment.” Instruction-based prompts may be used in connection with image-text encoder models 126 that implement language processing capabilities, for example, image-text encoder models 126 that include or receive output from large language models.

When used to generate corresponding pseudo-label data for training/updating the machine-learning model 126, the input text data 103 can be generated/determined to conform to a particular application, for example, to detect objects/features that typically occur within a particular environment (e.g., automotive environments, industrial environments, etc.). The input text data 103 can, in some implementations, be automatically generated using one or more classification models. For example, the classification models may be used to identify one or more objects/features of interest depicted in sets of image data 105. Objects/features appearing most frequently (e.g., configurable by one or more hyperparameters) can be converted into a text-based list format and used as input text data 103 for the techniques described herein. The data processing system 102 system can receive the input text data 103 through various channels such as application programming interface (API) calls, file uploads/network communications, or direct user input via a graphical interface.

When generating pseudo-labels for training/updating the machine-learning model 126 as described in further detail herein, the data processing system 102 can receive or otherwise access input image data 105 that corresponds to the input point cloud(s) 104. The input image data 105 can include visual information captured concurrently with a corresponding input point cloud 104. The input image data 105 can depict the same or a similar (e.g., partially overlapping) environmental scene from a corresponding viewpoint and may be acquired by sensors mounted on mobile platforms such as autonomous vehicles. To ensure spatial alignment between the image data 105 and the input point cloud 104, the sensor capturing the input image data 105 may share similar pose or orientation characteristics with the sensor(s) responsible for acquiring the input point cloud 104.

The format of the input image data 105 may include any suitable image format. Example formats may include red-green-blue (RGB) images. An RGB image provides color information and texture details for each pixel. A depth map represents distance measurements from a sensor to each point in the scene, often generated using time-of-flight or structured light techniques. The image data 105 can have a format and/or structure that conforms to an input of the vision-based machine-learning model 122, such that the vision-based machine-learning model 122 can generate segmentations/classifications for objects/features appearing in the image data 105.

The data processing system 102 can receive or otherwise access the input image data 105 using any suitable technique, including API calls from onboard processing units, file uploads/network communications with an external computing device, or direct user input via a graphical interface. In some implementations, the input image data 105 may be generated automatically by imaging sensors integrated with a sensor system on a vehicle, such as a car, truck, or other type of vehicle. The output of these sensors can then be processed and formatted into suitable formats before being used in conjunction with the corresponding input point cloud 104 for the techniques described herein.

The data processing system 102 can execute the vision-based machine-learning model 122 to generate segmentation pseudo-labels for input point clouds 104, which are stored in part as the segmentation masks 116 in the dataset 110. The data processing system 102 can generate the segmentation masks 116 for any number of input image data 105 and transfer the segmentation masks 116 to the corresponding input point clouds 104 using the segmentation mapper 124 as described in further detail herein. The data processing system 102 can perform the pseudo-label generation process using any number of image-point cloud pairs, in order to automatically generate a dataset 110 that may be used to train/update the machine-learning model 126 to accurately generate segmented point clouds 130.

The vision-based machine-learning model 122 can include any machine-learning model capable of generating segmentation masks 116 for input image data 105. The vision-based machine-learning model 122 may include a deep learning architecture that is trained/updated to perform semantic segmentation on input image data 105. The vision-based machine-learning model 122 may be implemented using convolutional neural networks (CNNs) or other machine-learning layers that can process visual information (e.g., pixel data) to learn hierarchical representations of objects/features within images. The vision-based machine-learning model 122 comprises multiple layers, each performing a specific operation on the input image data 105. Early layers may detect basic features such as edges and textures, while deeper layers progressively learn more abstract and semantically meaningful representations.

The vision-based machine-learning model 122 may be a pre-trained model that is trained/updated using pairs of input images and corresponding ground truth segmentation masks. The ground truth masks can provide pixel-level annotations indicating the class or category of each pixel in the image. The training/update process for the vision-based machine-learning model 122 can adjust the internal parameters of the vision-based machine-learning model 122 using backpropagation and optimization techniques to minimize the prediction error. The vision-based machine-learning model 122 may be received/accessed via one or more external computing devices or stored in memory of and executed by the data processing system 102.

The trained/updated vision-based machine-learning model 122 can generate one or more segmentation masks 116 for an unseen input image data 105 by processing the image through its learned feature hierarchy and applying a classification layer at the output to assign a class label to each pixel. These generated segmentation masks 116 can delineate regions of interest within the input image data 105 that indicate object or feature identification and localization. In some implementations, the vision-based machine-learning model 122 may be fine-tuned on specific datasets or tasks to improve its performance in particular domains or applications, such as automotive applications, navigation applications, or industrial applications.

The vision-based machine-learning model 122 may be implemented using a Segment Anything Model (SAM), which is a transformer-based model trained/updated to generate segmentation masks 116 for arbitrary objects or regions in the input image data 105. The vision-based machine-learning model 122 processes the input image data 105 to generate a set of segmentation masks 116 that accurately delineate different objects/features within the input image data 105. Segmentation masks 116 generated by the data processing system 102 can be stored as part of a dataset 110, in some implementations, or otherwise maintained/stored in memory of the data processing system 102 for further processing. The segmentation masks 116 can represent spatial regions within input image data 105 that correspond to specific objects or features identified by the vision-based machine-learning model 122. Each segmentation mask 116 can be assigned a unique label, representing the class or category of the object/feature it corresponds to. In some implementations, each pixel in a segmentation mask 116 can be assigned a unique label. These labels can be integers, strings, or other data types that uniquely identify each segmented region within an image. The segmentation masks 116 may often be represented as multi-channel arrays where each channel corresponds to a different class label.

In some implementations, the data processing system 102 can perform a flattening process to generate a set of non-overlapping segmentation masks 116 for each input image 105. We start by generating an overlapping set of segmentation masks for each image (camera view) For example, the data processing system 102 can first generate an initial set of segmentation masks. The hierarchy of the initial set of output segmentation masks can then be flattened by non-maxima suppression (NMS) with a predetermined overlap threshold (e.g., a relatively small overlap threshold, etc.) to obtain a small, non-overlapping set of segmentation masks 116 per input image data 105. The segmentation masks may be, in some implementations, binary segmentation masks. In some implementations, during mask suppression, the initial set of segmentation masks can be sorted masks based on the mask area, which may favor entire objects/features over their parts and subparts.

The data processing system 102 can store the segmentation masks 116 in association with corresponding identifiers of segmentation tokens 114, input point cloud data 104, and/or image data 105 within the dataset 110. This association may be stored using corresponding identifiers, such as file names or numerical indices, to indicate that each segmentation mask 116 corresponds to respective input text data 103, input image data 105, and/or input point cloud data 104. The dataset 110 can be structured as a database, a directory of files, or any other suitable format that allows for efficient storage and retrieval of the associated data. Although shown as separate from the data processing system 102, it should be understood that in some implementations, the dataset 110 may be included as part of the data processing system 102.

The data processing system 102 can execute an image-text encoder model 128 to generate one or more tokens 114 that represent the classification of corresponding objects/features detected in the input image data 105. Each set of tokens 114 are associated with corresponding segmentation mask(s) 116 in the dataset and are used to indicate the classification of the objects/features covered/indicated by the segmentation masks 116. Note that any classifications generated by the vision-based machine-learning model 122 may not necessarily be used in further operations, and instead the tokens 114 can be used to train/update the machine-learning model 126 to accurately segment and classify objects/features in input point clouds 104.

The image-text encoder model 128 can include any type of machine-learning model that is trained/updated to map visual information from images to textual representations. This mapping enables the image-text encoder model 128 to associate semantic concepts with visual features, and as such the image-text encoder model 128 can generate output tokens 114 representing text data that represent concepts depicted in input image data. In some implementations, the image-text encoder model 128 can include a contrastive language-image pre-training (CLIP model) that is trained/updated on a dataset of paired image-text data.

The image-text encoder model 128 can be implemented using transformer layers, convolutional layers, or other machine-learning layers. The data processing system 102 can execute the image-text encoder model 128 to generate tokens 114 that represent the classification of objects/features within a given segmentation mask 116. In some implementations, the data processing system 102 can provide image data 105 corresponding to all segmentation masks 116 to the image-text encoder model 128 at the same time. In some implementations, the data processing system 102 may process each segmentation mask 116 independently by extracting the corresponding portion of the input image data 105 and providing it into the image-text encoder model 128. The data processing system 102 can execute the image-text encoder model 128 to generate a set of tokens 114 that represent the most likely class labels for the objects/features present in the image data 105 corresponding to the segmentation mask 116. The tokens 114 generated by the image-text encoder model 128 can be used to train/update the machine-learning model 126, as described in further detail herein. The tokens 114 can be stored in the dataset 110 in association with corresponding segmentation masks 116, input image data 105, input point cloud data 104, and/or input text data 103.

The data processing system 102 can generate a transferred segmented point cloud 118 by transferring the set of segmentation masks 116 generated from an input image 105 to the input point cloud 104 to which the image 105 corresponds (e.g., captured to depict the same environment, etc.). In some implementations, segmentation masks 116 from multiple images (e.g., multiple angles/viewpoints) can be transferred to the point cloud 104. The data processing system 102 can perform such operations by unprojecting each segmentation mask 116 in the space of the input image data 105 to the space of the corresponding input point cloud 104.

The data processing system 102 can execute the segmentation mapper 124 to map the segmentation masks 116 in image-space to the space of the input point cloud 104. The segmentation mapper 124 can include hardware, software, or combinations of hardware and software. The transformation implemented by the segmentation mapper 124 can include establishing a correspondence between the pixel coordinates of the segmentation mask 116 and the three-dimensional (3D) coordinates of the points in the point cloud 104. To determine this correspondence, the segmentation mapper 124 may employ techniques such as depth estimation from the input image data 105, use pre-existing dense depth maps associated with the input image data 105, or use LiDAR and camera sensor calibration data.

The segmentation mapper 124 can align the coordinate frames of the input image data 105 and the input point cloud 104 to accurately perform unprojection from the image space to the point cloud space. This alignment can be achieved using various techniques, such as camera pose estimation or simultaneous localization and mapping (SLAM). Once the coordinate frames are aligned, each pixel in a segmentation mask 116 can be projected onto the corresponding points in the point cloud 104 by associating. This projection effectively transfers the semantic information encoded in the segmentation mask 116 to the spatial coordinates of the point cloud data based on the relative differences in pose/orientation of the image sensors that captured the image data 105 and the sensor(s) that captured the point cloud data 104.

In doing so, the segmentation mapper 124 may generate rotation and/or translation matrices/data structures that transform pixels in the image space (e.g., of the input image 105) into corresponding 3D locations in the point cloud 104. In doing so, the segmentation mapper 124 can associate each pixel in the 2D segmentation masks 116 with a corresponding 3D point in the point cloud 104. The resulting transferred segmented point cloud 118 can include a set of point cloud masks, each corresponding to a specific segmentation mask 116 from the input image data 105. Each point cloud mask is associated with a corresponding set of tokens 114, which are the same tokens 114 generated using the image-text encoder model 128 based on the corresponding segmentation mask 116. In some implementations, each point within the point cloud masks is associated with a corresponding set of tokens 114.

In some implementations, overlapping point cloud masks may be merged using a union operation to create larger, contiguous regions representing combined objects or features, for example, if the overlapping area/volume exceeds a predetermined size threshold. In some implementations, segmentation masks 116 transferred to the point cloud 104 can be omitted if their transformed size/mapping fails to satisfy a threshold number of point cloud 104 points, or if the point cloud points 104 fail to satisfy certain criteria (e.g., signal sparsity or lack of coverage). Point cloud segmentation masks that do not significantly overlap and are not excluded due to size may be retained as individual masks.

In some implementations, the segmentation mapper 124 can implement a clustering process, such as a density-based cluster of applications with noise (DBSCAN) clustering process to improve the quality of the transferred segmented point clouds 118. To do so, the segmentation mapper 124 can remove ground points from the point cloud 104 by using techniques such as plane fitting and ground estimation algorithms. The remaining non-ground points are then clustered into segments based on their spatial density, using, for example, six predefined density thresholds to generate a set of overlapping segmentation masks. Each cluster identified by DBSCAN represents a potential object or feature within the point cloud 104. The resulting collection of clusters can form an ensemble of possible segmentations for each input image 105. The segmentation mapper 124 can then compare these DBSCAN-generated clusters with the initial segmentation masks transferred to the point cloud 104, identifying those that exhibit a significant overlap (based on a predefined IoU threshold). The best matching DBSCAN cluster can be selected to replace the corresponding transferred segmentation mask, effectively refining the transferred segmented point cloud 118 and improving its accuracy with respect to detected objects or features.

The data processing system 102 can iteratively repeat this process for pairs of input point cloud data 104 and input image data 105 to generate the dataset 110, which is shown as including sets of tokens 114, segmentation masks 116, and transferred segmented point clouds 118. The tokens 114 and the transferred segmented point clouds 118 can be used to train/update the machine-learning model 126 to automatically segment point clouds 104 directly without performing the transformation steps to generate the transferred segmented point clouds 118. Further details of the training/update process for the machine-learning model 126 are described herein.

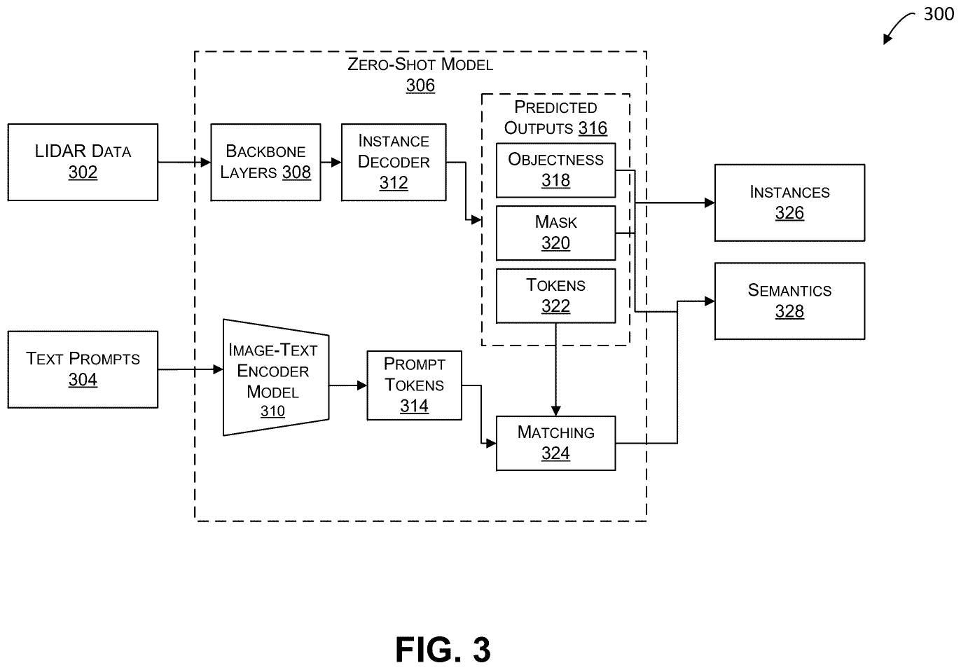

The data processing system 102 can execute the model updater 120 to update the machine-learning model 126. The machine-learning model 126 can include convolutional layers, transformer layers, and in some implementations other machine-learning layers. An example architecture of the machine-learning model 126 is shown and described in connection with FIG. 3. In some implementations, the machine-learning model 126 can include the image-text encoder model 128, which can be frozen during the training/update process for the machine-learning model 126. The machine-learning model 126 can be trained/updated to receive input text data 103 and input point clouds 104 as input and generate segmented point clouds 130 as output. The machine-learning model 126 can be trained/updated according to the techniques described herein to segment and classify any object represented in an input point cloud 104. Target/desired objects/features that are to be segmented can be specified via the input text data 103.

In some implementations, prior to training/updating the machine-learning model 126, the segmentation mapper 124 can process the transferred segmented point clouds 118 to improve data quality. In some implementations, the segmentation mapper 124 can remove one or more points from the transferred segmented point clouds 118. For example, the pseudo-label generation techniques implemented by the segmentation mapper 124 may only provide partial supervision within the camera field of view of the camera, which may only represent a subset of the points of the point cloud 104 (which may represent a 360-degree environment around a vehicle, in some implementations). This results in a subset of the points in the transferred segmented point cloud 118 being unlabeled, particularly in circumstances where the view of view of the sensor that generated the point cloud 104 greatly exceed the field of view of the image sensor(s) that captured the input image(s) 105 corresponding to the point cloud 104. To avoid false-positive penalties for segmentations generated for these unlabeled regions, the segmentation mapper 124 can remove any unlabeled (e.g., unmapped) points from the transferred segmented point clouds 118 prior to or during training/updating the machine-learning model 126.

In some implementations, the segmentation mapper 124 can perform data augmentation techniques to generalize the mapped segmentations of the transferred segmented point clouds 118 to full point clouds 104. In one example, the segmentation mapper 124 can perform a variant of frustum augmentation, by randomly removing unlabeled points from the transferred segmented point clouds 118 and replicating labelled frustum regions in the transferred segmented point clouds 118 about a vertical access of the transferred segmented point clouds 118. The segmentation mapper 124 can implement such techniques to mimic fully labeled transferred segmented point clouds 118 in circumstances where actual label data cannot be derived from image data 105. One example augmentation approach that may be implemented by the segmentation mapper 124 includes FrankenFrustum augmentation.

Once the segmentation mapper 124 has generated transferred segmented point clouds 118 for a sufficient number of pairs of image data 105 and point cloud data 104, the data processing system 102 can execute the model updater 120 to train/update the machine-learning model 126. To train/update the machine-learning model 126, the model updater 120 can train/update the machine-learning model 126 jointly for both class-agnostic segmentation and zero-shot classification using the following example loss:

$${ℒ}_{SAL} = {ℒ}_{obj} + {ℒ}_{seg} + {ℒ}_{token}$$

In the above loss, [symbol] _{SAL} can be the total loss that is to be optimized, [symbol] _{obj} can be a binary cross-entropy loss corresponding to object detection at a particular point in the point cloud, [symbol] _{seg} can be a combination of a binary mask cross-entropy loss and dice loss, and [symbol] ₜₒₖₑₙ can be a cosine distance loss. The object loss [symbol] _{obj} can measure how well the machine-learning model 126 recognizes objects within an image (e.g., indicating whether the corresponding point cloud 104 point corresponds to an object/feature). The object loss can be calculated based on objectness scores predicted by the machine-learning model 126 for each input point of the input point cloud 104. The segmentation loss [symbol] _{seg} can measure how well the machine-learning model 126 assigns each point of the input point cloud 104 to a respective segmentation label. The token loss [symbol] ₜₒₖₑₙ is used to optimize the error between predicted tokens generated by the machine-learning model 126 given the input point cloud 104 and corresponding tokens 114 in the dataset 110 generated from the corresponding image data 105.

Any suitable version of these losses can be implemented to train/update the machine-learning model 126. To train/update the machine-learning model 126, the model updater 120 can iteratively provide input point clouds 104 for which transferred segmented point clouds 118 and corresponding tokens 114 were generated as input to the machine-learning model 126 to generate output data. To update the machine-learning model 126, the model updater 120 can compare the predicted outputs of the ground truth labels provided in the corresponding transferred segmented point clouds 118 and associated tokens 114. The difference between the predicted and actual values can be calculated as the composite loss function, which quantifies the error made by the model. The model updater 120 can use an optimization algorithm (e.g., stochastic gradient descent, Adam optimizer, etc.) to adjust the trainable/updatable parameters of the machine-learning model 126 in a direction that minimizes this loss function. This iterative process can continue for multiple batches and/or epochs of training/update data in the dataset 110, which gradually improves the accuracy of the machine-learning model 126 until a termination condition is satisfied.

One example termination condition includes providing a predefined number of epochs of training/update data to the machine-learning model 126, where an epoch represents one full pass through the entire dataset 110. Another criterion may involve a validation loss of the machine-learning model 126 satisfying a threshold. The validation loss can measure the performance of the machine-learning model 126 on a separate subset of data not used for training/updating (e.g., validation set). Furthering this example, training/updating can be terminated when the validation loss plateaus or starts to increase, indicating potential overfitting. In some implementations, termination conditions can be satisfied when a predetermined target accuracy on a specific metric (e.g., Intersection over Union (IoU), etc.) is met, indicating that the machine-learning model 126 has achieved a desired performance.

Once the machine-learning model 126 has been trained/updated by the model updater 120, the data processing system 102 can execute the machine-learning model 126 to generate segmented point clouds 130 using input point clouds 104 and input text data 103. For example, the data processing system 102 can identify one or more input point clouds 104 (e.g., captured using one or more sensors, etc.) and corresponding text data 103 that indicates which objects/features are to be segmented and classified in the input point cloud 104. In some implementations, the point cloud data 104 may be received from one or more sensors and the text data 103 can be identified or retrieved from one or more configuration settings. In some implementations, point cloud data 104 and text data 103 can be provided from an external computing system via one or more API calls.

Once point cloud data 104 and text data 103 is identified, the data processing system 102 can provide the text data 103 and point cloud data 104 to the machine-learning model 126. As described in connection with FIG. 3, the machine-learning model 126 can in some implementations include the image-text encoder model 128. Executing the machine-learning model 126 can include propagating the input point cloud 104 through one or more layers of the machine-learning model 126 and propagating the text data 103 through the image-text encoder model 128 to generate a set of prompt tokens. The machine-learning model 126, when executed, can produce a predicted set of tokens, a predicted objectness score for each point in the input point cloud 104, and predicted segmentations (which may include an identifier of one or more token(s), representing a corresponding class) for each point in the input point cloud 104. Each transformer query of the machine-learning model 126 can predict an objectness score, semantic token, and foreground background binary segmentation mask for each point in the input point cloud 104.

The segmentations and objectness scores can be stored in association with each point in the point cloud 104 and can be stored as the segmented point cloud 130. The data processing system 102 can perform zero-shot classification by zero-shot classification via matching the tokens output by the machine-learning model 126 with those predicted by the image-text encoder model 128 (e.g., label tokens). Predicted tokens that match the label tokens output by the image-text encoder model 128 based on the class vocabulary (e.g., a set of labels) specified in the text data 103 can indicate which classes of objects/features are present in the segmented point cloud 130.

Using these techniques, the data processing system 102 can train/update and execute a machine-learning model 126 to perform panoptic and class-agnostic point cloud segmentation with zero-shot classification. The segmented point cloud(s) 130 generated using the machine-learning model 126 can be stored for further processing, provided to one or more processes/applications that requested processing of the point cloud 104, or provided to one or more external computing systems that transmitted the point cloud 104 via one or more requests or API calls.

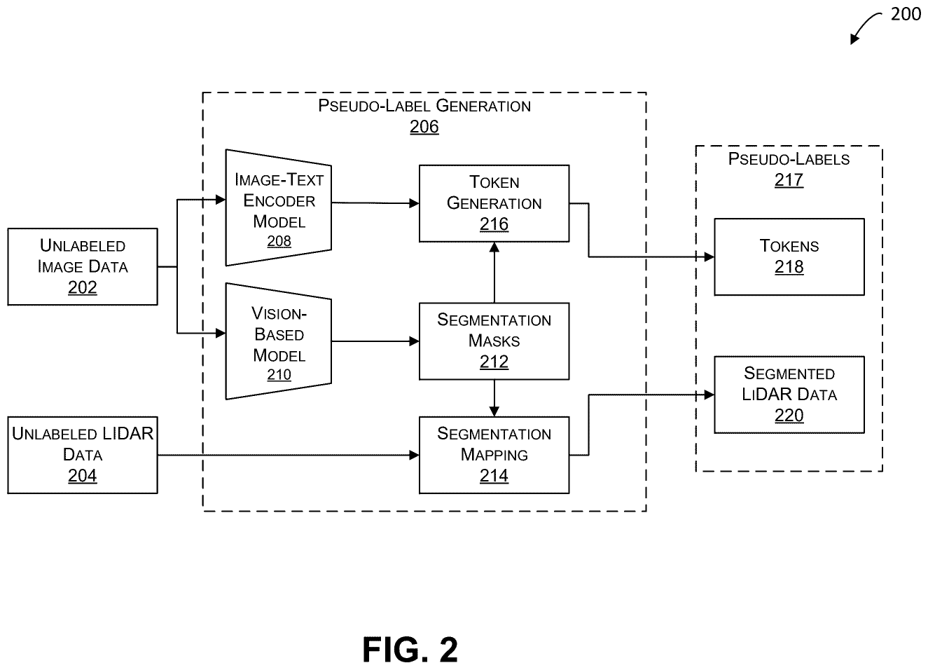

Referring to FIG. 2 in the context of the components described in connection with FIG. 1, depicted is a block diagram 200 showing an example implementation of a pseudo-label generation process 206 performed according to the techniques described herein, in accordance with some embodiments of the present disclosure. As shown, unlabeled image data 202 (e.g., input image data 105) and corresponding unlabeled LiDAR data 204 (e.g., an input point cloud 104 capturing a same environment as the input image data 105) can be used to generate pseudo-labels 217 for the unlabeled LiDAR data 204. The pseudo-labels 217 can be used as ground-truth data for the unlabeled LiDAR data 204 during the training/update processes described herein (e.g., for training/updating the machine-learning model 126).

As shown, the pseudo-label generation process includes providing the unlabeled image data 202 as input to the image-text encoder model 208 (e.g., the image-text encoder model 128) and the vision-based model 210 (e.g., the vision-based machine-learning model 122). The vision-based model 210 can be trained/updated to generate one or more segmentation masks 212 (e.g., segmentation mask(s) 116) and the image-text encoder model 208 is trained/updated to process the image data corresponding to the segmentation masks 212 and generate corresponding tokens 218 (e.g., tokens 114) using a token generation process 216. The tokens 218 can be an encoded representation of the objects/features in the unlabeled image data 202 segmented by the vision-based model 210.

The segmentation masks 212 generated using the vision-based model 210 can then be mapped to the unlabeled LiDAR data 204 using the segmentation mapping process 214 (e.g., performing the techniques described in connection with the segmentation mapper 124 of FIG. 1). This results in generation of the segmented LiDAR data 220, provided as part of the pseudo-labels 217. In some implementations, the segmentation mapping process 214 can include performing various filtering or data augmentation techniques to improve the quality of the segmented LiDAR data 220 (e.g., transferred segmented point clouds 118). The segmented LiDAR data 220, together with corresponding tokens 218 encoding the classes of the segmentations, can be used as ground truth data to train/update a panoptic LiDAR segmentation model (e.g., the machine-learning model 126) to perform zero-shot classification and segmentation, as described herein.

Referring to FIG. 3 in the context of the components described in connection with FIGS. 1 and 2, depicted is a block diagram 300 showing an example implementation of a zero-shot model 306 (e.g., the machine-learning model 126) updated using the pseudo-labels described herein (e.g., the pseudo labels 217 of FIG. 2, etc.), in accordance with some embodiments of the present disclosure. As shown, during inference, the zero-shot classification and segmentation model 306 can receive input LiDAR data 302 (e.g., an input point cloud 104) and input text prompt(s) 304 (e.g., text data 103). The text prompt(s) 304 may provide a class vocabulary of different classes to detect/segment in the LiDAR data 302.

The LiDAR data 302 can be provided as input to one or more convolutional backbone layers 308, which can include any suitable 3D feature detection backbone. In one example, the backbone layers 308 can include a Minkowski U-Net backbone model, which can generate voxel features from the LiDAR data 302 which may be provided as input to one or more transformer layers of an instance decoder 312. The instance decoder 312 can also receive one or more object queries as input, which may be learned during training/updating of the zero-shot model 306. The instance decoder 312 can be trained/updated to compute cross-attention between the object queries and features extracted by the backbone layers 308. The instance decoder 312 can include a number of task output heads that generate the predicted outputs 316. In one example the instance decoder 312 includes three task heads that predict objectness scores 318, segmentation masks 320, and tokens 322 for each query.

In this example, the zero-shot model 306 is shown as including the image-text encoder model 310 (e.g., the image-text encoder model 128). However, it should be understood that the image-text encoder model 310 may be frozen and not necessarily be trained/updated with the other trainable layers (e.g., the backbone layers 308, the instance decoder layers 312, etc.) of the zero-shot model 306. The image-text encoder model 310 can generate corresponding prompt tokens 314, which can encode the input list of desired/target objects/features that are to be segmented/detected in the LiDAR data 302. The machine process 324 can be used to identify tokens 322 that match prompt tokens 314, indicating that the LiDAR data 302 includes the corresponding desired/target class of object feature. These matching features can be provided as semantic data 328. The objectness scores 318 and mask data 320 for each point in the input LiDAR data 302 can be provided as the instance data 326. The instance data 326 and the semantic data 328 can be provided with the input LiDAR data 302 as a segmented point cloud (e.g., a segmented point cloud 130).

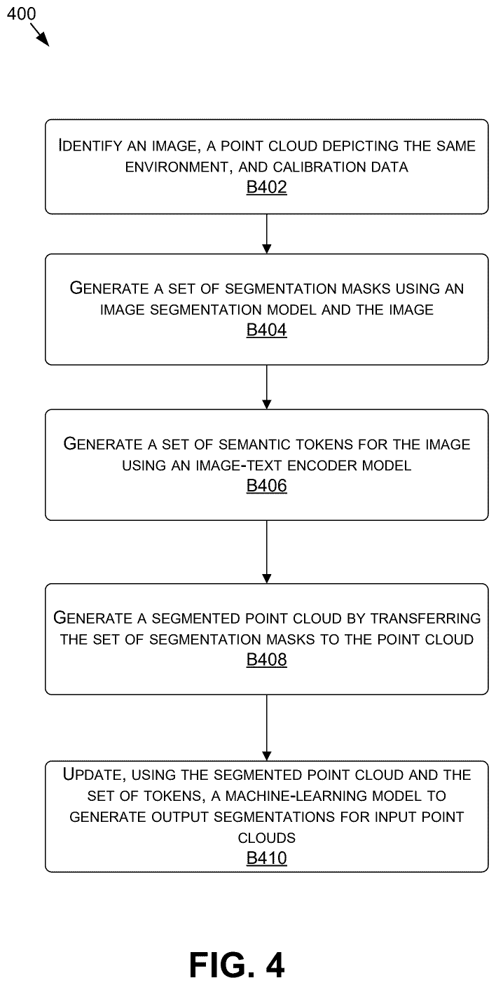

Now referring to FIG. 4, each block of method 400, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIG. 1. However, this method may additionally or alternatively be executed by any one system, or any combination of systems, including, but not limited to, those described herein.

FIG. 4 is a flow diagram showing a method 400 for training/updating and executing machine-learning models for segmenting objects/features in point clouds. The method 400, at block B402, includes identifying an image (e.g., input image data 105) and a point cloud (e.g., a point cloud 104) depicting the same environment. The image and point cloud may be captured by sensors present on the same vehicle, in one example. The sensors used to capture the image and point cloud may be positioned to capture the same region of an environment including one or more objects or features. The image and point cloud may be received from sensor(s), via one or more API calls or requests, or from another process/application via inter-process communication.

The method 400, at block B404, includes generating a set of segmentation masks (e.g., segmentation masks 116) using an image segmentation model (e.g., the vision-based machine-learning model 122) and the image. The image segmentation model can include a convolutional neural network model that generates output segmentations for an input image. The image segmentation model can be a pre-trained model that generates corresponding segmentations for any number of objects/features. In some implementations, the image segmentation model can be a class-agnostic segmentation model (e.g., a segment anything model (SAM), etc.). Generating the set of segmentations can include providing the image as input to the model. In some implementations, the set of segmentations can be flattened via a non-maxima suppression algorithm according to a minimal overlap threshold.

The method 400, at block B406, includes generating a set of tokens for the image using an image-text encoder model (e.g., the image-text encoder model 128). The image-text encoder model can receive image data (e.g., regions of pixels, etc.) as input and can generate corresponding tokens representing labels for different objects/features represented in the image. In some implementations, tokens can be generated for each segmentation mask of the image generated at block 404. For example, pixels corresponding to each mask can be provided iteratively as input to the image-text encoder model to generate one or more sets of tokens for each segmentation mask. In some implementations, the entire image can be provided as input to the image-text encoder model, generating all tokens for all segmentation masks in one iteration. The set of tokens can be associated with the corresponding segmentations, for example, in one or more datasets (e.g., the dataset 110).

The method 400, at block B408, includes generating a segmented point cloud (e.g., a transferred segmented point cloud 118) by transferring the set of segmentation masks to the point cloud. Transferring the segmentation masks can be performed by implementing any of the functionality of the segmentation mapper 124 described in connection with FIG. 1. In some implementations, transferring the segmentation masks can include unprojecting the segmentation masks to the 3D coordinate space of the point cloud. In some implementations, one or more clustering techniques (e.g., DBSCAN) can be used to improve the quality of segmentations transferred to the point cloud.

In some implementations, the segmented point cloud, once generated, can be processed to improve its quality for training/updating a machine-learning model in subsequent steps of the method 400. For example, in some implementations unlabeled points (e.g., not corresponding to an object, etc.) can be removed from the segmented point cloud. In some implementations, data augmentation may be used, such as FrankenFrustum, to mimic a full segmentation of a point cloud. The processed segmented point cloud, together with the corresponding set of tokens, can be used as pseudo-labels for the input point cloud during a training/update process for a machine-learning model (e.g., the machine-learning model 126). In some implementations, blocks B402-B408 can be repeated to generate a training/update dataset (e.g., a dataset 110) storing many segmented point clouds, tokens, and input point clouds.

The method 400, at block B410, includes updating, using the segmented point cloud and the set of tokens, a machine-learning model (e.g., the machine-learning model 126) to generate output segmentations for input point clouds. Training/updating the machine-learning model can include performing any of the operations described in connection with the model updater 120 of FIG. 1. In some implementations, the machine-learning model comprises one or more transformer layers (e.g., instance decoder 312) and one or more convolutional layers (e.g., backbone layers 302). The machine-learning model can be trained/updated generate predicted tokens, segmentations, and objectness scores for the points in an input point cloud, as described herein.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Autonomous Vehicle

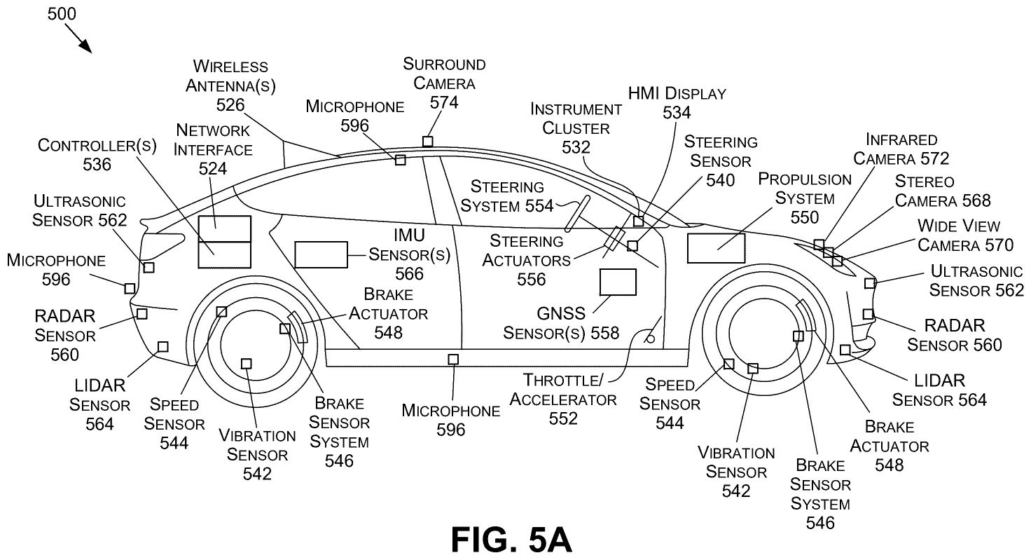

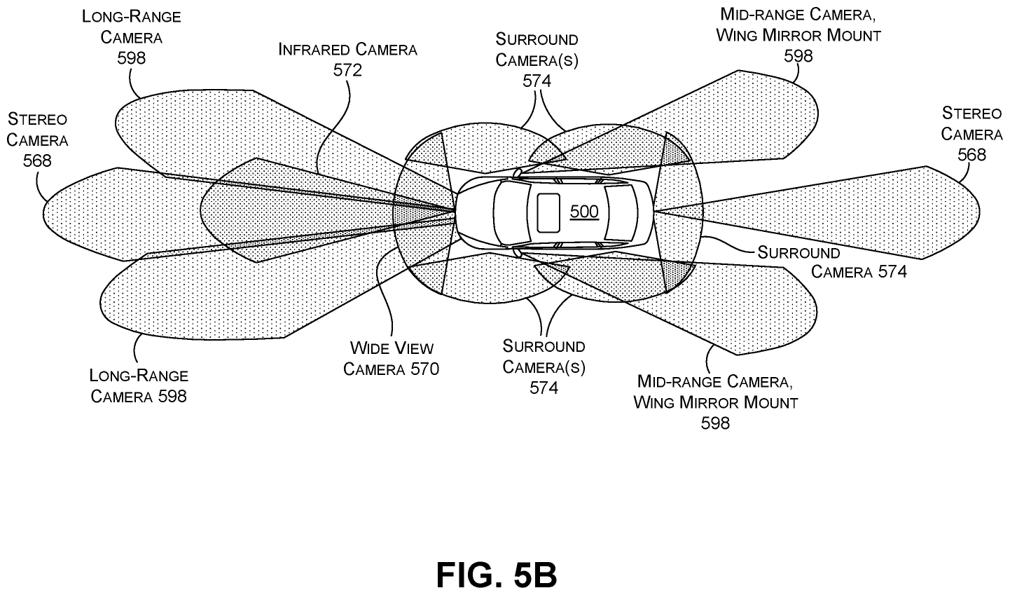

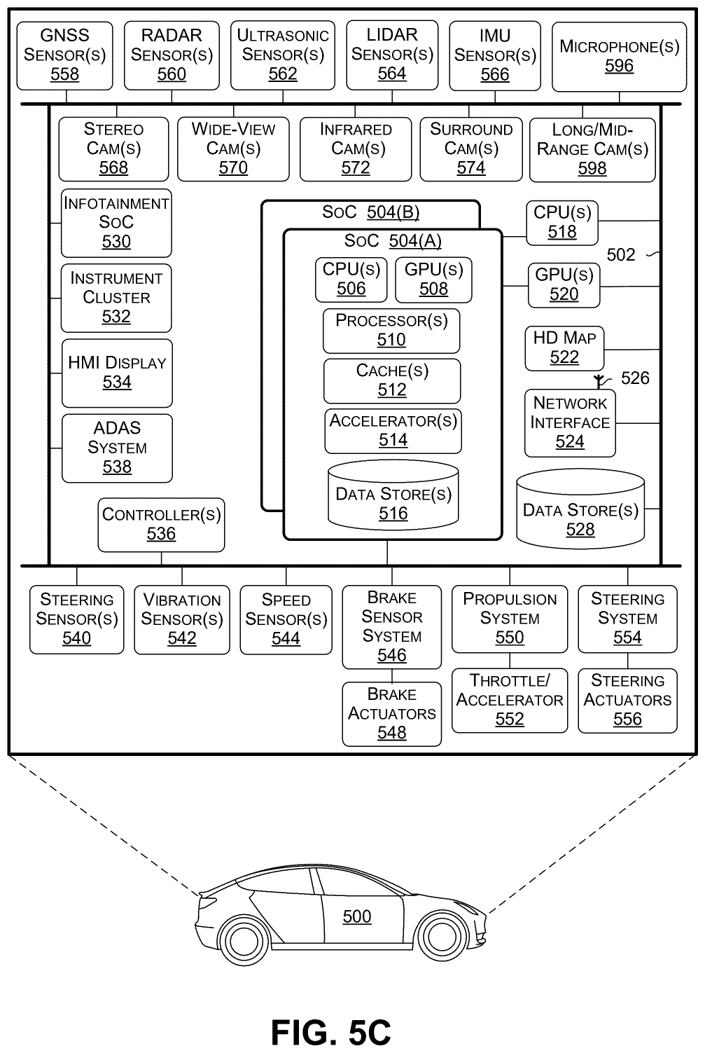

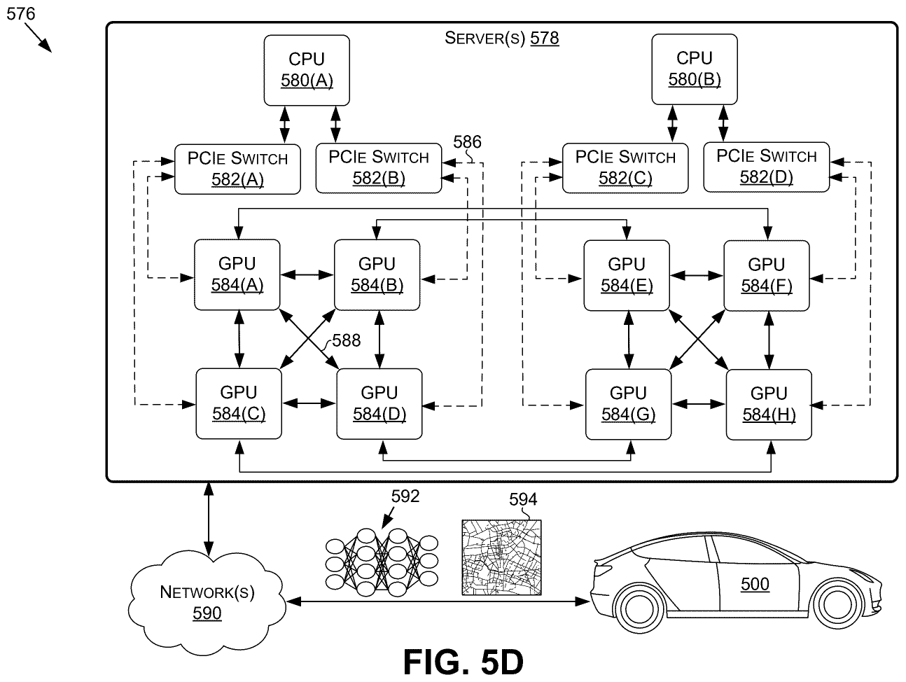

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LiDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) (e.g., as part of the brake sensor system 546), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the High Definition (“HD”) map 522 of FIG. 5C), location data (e.g., the vehicle's 500 location, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524 which may use one or more wireless antenna(s) 526 and/or modem(s) to communicate over one or more networks. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may be any number (including zero) of wide-view cameras 570 on the vehicle 500. In addition, any number of long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

Any number of stereo cameras 568 may also be included in a front-facing configuration. In at least one embodiment, one or more of stereo camera(s) 568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360 degree camera(s), and/or the like. Four example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C are illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500 and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power optimized for best performance in automotive and embedded use cases. For example, the GPU(s) 508 may be fabricated on a Fin field-effect transistor (FinFET). However, this is not intended to be limiting and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, which may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LiDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 512 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high-dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LiDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surroundings at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 560 m (front) or 80 m (rear), and a field of view of up to 42 degrees (front) or 550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LiDAR sensor(s) 564. The LiDAR sensor(s) 564 may be used for object and pedestrian detection, emergency braking, collision avoidance, and/or other functions. The LiDAR sensor(s) 564 may be functional safety level ASIL B. In some examples, the vehicle 500 may include multiple LiDAR sensors 564 (e.g., two, four, six, etc.) that may use Ethernet (e.g., to provide data to a Gigabit Ethernet switch).

In some examples, the LiDAR sensor(s) 564 may be capable of providing a list of objects and their distances for a 360-degree field of view. Commercially available LiDAR sensor(s) 564 may have an advertised range of approximately 500 m, with an accuracy of 2 cm-3 cm, and with support for a 500 Mbps Ethernet connection, for example. In some examples, one or more non-protruding LiDAR sensors 564 may be used. In such examples, the LiDAR sensor(s) 564 may be implemented as a small device that may be embedded into the front, rear, sides, and/or corners of the vehicle 500. The LiDAR sensor(s) 564, in such examples, may provide up to a 120-degree horizontal and 35-degree vertical field-of-view, with a 200 m range even for low-reflectivity objects. Front-mounted LiDAR sensor(s) 564 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 500. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LiDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network which is trained and thus reduces the risk of false positives, as described herein.

The vehicle 500 may further include the infotainment SoC 530 (e.g., an in-vehicle infotainment system (IVI)). Although illustrated and described as a SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road-work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

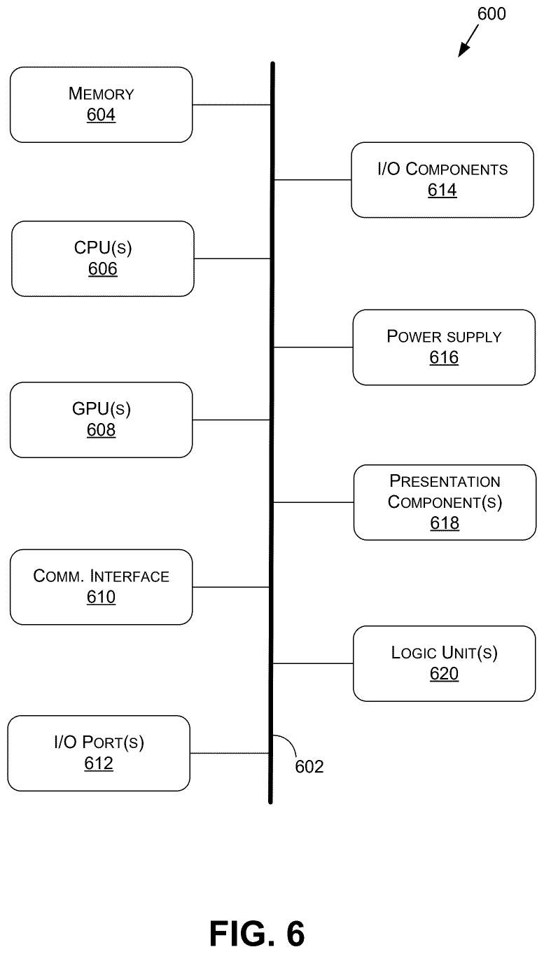

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

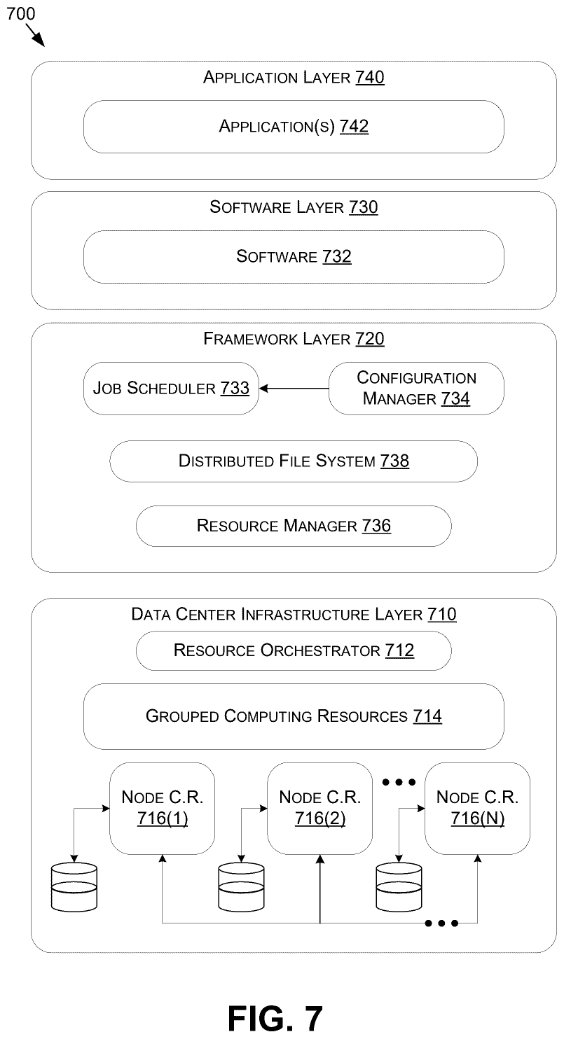

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
generate, for an image depicting an environment, a set of segmentation masks using an image segmentation model and the image;
generate a set of tokens for the image using an image-text encoder model;
generate a segmented point cloud by transferring the set of segmentation masks to a point cloud representing at least a portion of the same environment depicted by the image; and
update, using the segmented point cloud and the set of tokens, a machine-learning model to generate output segmentations for input point clouds.

2. The one or more processors of claim 1, wherein the one or more circuits are to:
remove at least one unlabeled point from the segmented point cloud.

3. The one or more processors of claim 1, wherein the machine-learning model comprises one or more transformer layers and one or more convolutional layers.

4. The one or more processors of claim 1, wherein the one or more circuits are to:
transfer the set of segmentation masks to the point cloud further based at least on a density-based clustering function.

5. The one or more processors of claim 1, wherein the one or more circuits are to:
update the segmented point cloud using an augmentation function.

6. The one or more processors of claim 1, wherein the one or more circuits are to:
generate an initial set of segmentation masks by providing the image as input to the image segmentation model; and
generate the set of segmentation masks using a non-maximum suppression function.

7. The one or more processors of claim 1, wherein the one or more circuits are to:
generate the set of tokens using the image-text encoder model further based at least on the set of segmentation masks.

8. The one or more processors of claim 1, wherein the one or more circuits are to:
identify an input point cloud and an input prompt indicating a set of labels;
generate a set of label tokens using the image-text encoder model and the set of labels; and
generate an output segmentation for the input point cloud using the machine-learning model and the set of label tokens, the output segmentation corresponding to the set of labels.

9. The one or more processors of claim 8, wherein the one or more circuits are to:
generate a set of output tokens using the machine-learning model; and
identify at least one match between the set of tokens and the set of output tokens.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing operations using a large language model (LLM);
a system for performing operations using a vision language model (VLM);
a system for performing operations using a multi-modal language model;
a system for generating synthetic data;
a system incorporating one or more virtual machines (VMs);
a system implemented at least partially in a data center; or
a system implemented at least partially using cloud computing resources.

11. A system, comprising:
one or more processors to:
obtain, using sensor data captured using a sensor, a point cloud representative of one or more objects in an environment;
generate, using an image-text encoder model, a set of label tokens corresponding to a set of labels corresponding to the one or more objects; and
generate, using a machine-learning model, the point cloud, and the set of label tokens, a segmented point cloud identifying at least one label of the set of labels, wherein the machine-learning model is updated based on one or more outputs of at least one of an image segmentation model or an image-text encoder model.

12. The system of claim 11, wherein the image-text encoder model is included as part of the machine-learning model, and the one or more processors are to provide the point cloud and the set of classes as input to the machine-learning model to generate the segmented point cloud.

13. The system of claim 11, wherein the machine-learning model comprises one or more transformer layers and one or more convolutional layers.

14. The system of claim 11, wherein the one or more processors are to:
receive the set of labels in a text prompt.

15. The system of claim 11, wherein the one or more processors are to:
generate the segmented point cloud to include a respective objectness score for at least one point of the point cloud.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing operations using a large language model (LLM);
a system for performing operations using a vision language model (VLM);
a system for performing operations using a multi-modal language model;
a system for generating synthetic data;
a system incorporating one or more virtual machines (VMs);
a system implemented at least partially in a data center; or
a system implemented at least partially using cloud computing resources.

17. A method, comprising:
generating, using one or more processors, a set of segmentation masks using an image segmentation model and an image depicting an environment;
generating, using the one or more processors, a set of tokens for the image using an image-text encoder model;
generating, using the one or more processors, a segmented point cloud by transferring the set of segmentation masks to a point cloud representing one or more objects in at least a portion of the same environment depicted by the image; and
updating, using the one or more processors, using the segmented point cloud and the set of tokens, a machine-learning model to generate output segmentations for one or more input point clouds.

18. The method of claim 17, further comprising:
removing, using the one or more processors, at least one unlabeled point from the segmented point cloud.

19. The method of claim 17, wherein the machine-learning model comprises one or more transformer layers and one or more convolutional layers.

20. The method of claim 17, further comprising:
transferring, using the one or more processors, the set of segmentation masks to the point cloud further based at least on a density-based clustering function.
